(19) United States
(12) Patent Application Publication
(10) Pub. No.: US 2026/0014497 A1
(43) Pub. Date: Jan. 15, 2026

(54) FILTER ELEMENT FOR USE IN A FILTER SYSTEM

(71) Applicant: John Crane Inc., Morton Grove, IL (US)

(72) Inventors: Arnd Hartung, Ahnatal (DE); Marco Vent, Schauenburg (DE); Olaf Günther, Helsa (DE)

(21) Appl. No.: 19/259,583

(22) Filed: Jul. 3, 2025

Related U.S. Application Data
(60) Provisional application No. 63/668,864, filed on Jul. 9, 2024.

(51) Int. Cl. B01D 29/21; B01D 39/12; B01D 46/24

(52) U.S. Cl. CPC B01D 29/21; B01D 39/12; B01D 46/2411

(57) ABSTRACT

A filter cartridge and a filter system. The cartridge can include a support tube, and a mesh pack surrounding the support tube. The mesh pack includes: three or more wire mesh layers, wherein at least two of the wire mesh layers are adjacent to one another and rotated relative to one another or have different sizes; and a filtration layer arranged between the two of the three or more wire mesh layers.

### CROSS REFERENCE TO RELATED APPLICATIONS

This application claims the benefit of an earlier filing date from U.S. Provisional Application Ser. No. 63/668,864 filed Jul. 9, 2024, the entire disclosure of which is incorporated herein by reference.

### BACKGROUND

Exemplary embodiments of the present disclosure pertain to the art of systems and methods for creating filters to filter a fluid.

Typical liquid filters can be used to filter impurities out of a liquid. An example of such a filter can include a filter housing with one or more filter cartridges. The liquid is flowed into the filter housing and typically flows from an outer diameter of the filter cartridges into the inner diameter. The cartridges filter the liquid, and the cleaned liquid exits through the an exit opening of the cartridges. The liquid that exits the cartridges is collected at and leaves through an exit of the filter housing.

The cartridges can typically include round support tube surrounded by a mesh pack. The mesh pack can include a combination of a metal fiber fleece layer and one mor more wire mesh layers.

In industries where fluids can be highly contaminated with particles/gels (e.g., polymer recycling industry) more dirt holding capacity is needed to increase the time between filter cartridge change outs. Thus, there exists a need for filter cartridges that can be utilized with polymers that meet current demands and may allow for reducing the number of filter change outs (e.g., increasing time between filter change out outs).

### SUMMARY

The inventors hereof have discovered that by changing the arrangement and/or the number of metal mesh layers in the cartridges that the effective filtration area of the cartridge can be increased while the calculated filtration area remains the same or is only minimally changed.

The cartridge can include two of more wire mesh layers and, in particular, can include 5, 6 or more metal mesh layers in combination with at least one filtration layer. The filtration layer can be a woven medium such as Dutch Weave, a glass fiber fleece or a metal fiber fleece to name but a few. The filtration layer can include one or more protective layers sintered to it.

Each mesh layer can have defined “shaped holes” there through. Adjacent mesh layers may optionally be rotated relative to one another. In one embodiment, the layers are arranged so that the shaped holes of one layer are rotated about 45 degrees relative to an adjacent layer.

As the number of wire mesh layers in the cartridges herein has been increased relative to the prior art, the number of pleats in each layer can be reduced. The number of pleats is reduced because the layup is thicker and therefore less pleats fit on the same inner diameter/support tube as will be clear from the disclosure herein.

The standard design is a 3-layer mesh pack, which is densely pleated to maximize the surface area and give the pleats structural stability. As each pleat holds its neighbor upright when the force of the fluid tries to push them over and renders them unusable. For instance, thick polymer melts have higher flow resistance between the pleats in such a case that acts like a round tube, decreasing the effective filtration area.

In some instances, the calculated filter area of the disclosed cartridges may be slightly lower than the standard design because the number of pleats has been reduced. However, the reduced calculated area may result in improved filtering due to the arrangement of layers as disclosed herein. Stated differently, even if the real surface area is less compared to a standard mesh pack, the effective area is the same, or even higher in embodiments herein.

In one embodiment, the cartridge includes a mesh pack formed of metal mesh layers in combination with a sintered metal fiber fleece layer. In such a case, in one embodiment, the mesh pack include 6 total layers, 5 metal mesh layer and one fleece layer.

In one embodiment, the metal fiber fleece layer includes one or more wire mesh protective layers but that is not required. In one embodiment, the metal fiber fleece layer includes one or two wire mesh protective layers, sintered to one or both sides of the metal fiber fleece layer but such is not mandatory.

As noted above, the pleat height can be varied compared to prior art mesh packs. As will be understood from the teachings herein, height and quantity are dependent on the inner and outer diameters of the cartridge. By way of a non-limiting example, for a cartridge with a 60 mm diameter, the number of pleats may be decreased from 33 to 25, which corresponds to approximately 25% decrease from the standard mesh pack.

In one embodiment, by arranging the layers of the mesh pack as disclose herein, the “dirt holding capacity per unit filtration area” (measured in g/m² for example) can be increased by about 35% on average.

According to one embodiment, a filter cartridge is disclosed. The cartridge can include a support tube, and a mesh pack surrounding the support tube. The mesh pack includes: three or more wire mesh layers, wherein at least two of the wire mesh layers are adjacent to one another and rotated relative to one another or have different sizes; and a filtration layer arranged between the two of the three or more wire mesh layers.

In one embodiment, the at least two of the wire mesh layers are rotated between 30 and 60 degrees relative to one another.

In one embodiment, the at least two of the wire mesh layers are rotated 45 degrees relative to one another.

In one embodiment, the filtration layer is a metal fiber fleece.

In one embodiment, the metal fiber fleece layer is an un-unprotected metal fiber fleece.

In one embodiment, the cartridge can further include a protective layer attached to the metal fiber fleece.

In one embodiment, at least three of the three or more wire mesh layers surround the metal fiber fleece and the protective layer.

In one embodiment, the protective layer is formed of a wire mesh and is sintered to the metal fiber fleece layer.

In one embodiment, the protective layer is formed of a wire mesh that is the same as one of the three or more wire mesh layers.

In one embodiment, the three or more wire mesh layers includes four wire mesh layers that surround by the metal fiber fleece layer.

In one embodiment, the three or more wire mesh layers define square or rectangular holes therein.

In one embodiment, the metal fiber fleece layer includes a protective layer laminated to it.

In one embodiment, the three or more wire mesh layers include an inner layer surrounded by the metal fiber fleece.

In one embodiment, the three or more wire mesh layers include four wire mesh layers that surround the metal fiber fleece layer and the inner layer.

In one embodiment, the three or more wire mesh layers define square or rectangular holes therein.

Also disclosed is a filter system including any cartridges disclosed herein.

### BRIEF DESCRIPTION OF THE DRAWINGS

The following descriptions should not be considered limiting in any way. With reference to the accompanying drawings, like elements are numbered alike:

FIG. 1 shows a filter system that can incorporate the filter cartridges disclosed herein;

FIG. 2 is a section view of a complete example cartridge according to one embodiment;

FIG. 3 shows the mesh pack portion of cartridge of FIG. 2;

FIGS. 4A and 4B show example arrangements of wire mesh layers relative to one another;

FIG. 5 shows pleated wire mesh layers according to one embodiment;

FIG. 6 shows an example of a layer configuration according to one embodiment; and

FIG. 7 shows an example of a layer configuration according to one embodiment.

### DETAILED DESCRIPTION

A detailed description of one or more embodiments of the disclosed apparatus and method are presented herein by way of exemplification and not limitation with reference to the Figures.

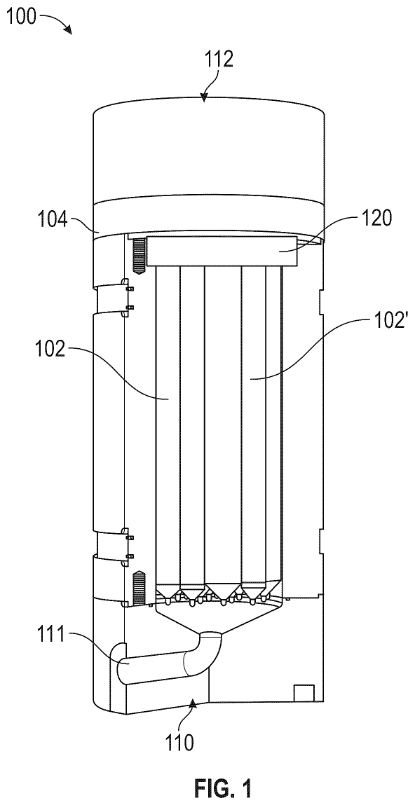

As noted above, FIG. 1 a filter system 100 that can incorporate the filter cartridges 102 disclosed herein. The filter cartridges 102 can be referred to as filter elements or candles from time to time herein. The filter system 100 includes a housing 104 in which the filter cartridges 102 are housed. The housing 104 has first and second ends 110, 112 that may be referred to as inlet and outlet ends herein.

As discussed more fully below, one or more of the cartridges 102 can include a several layers of pleated wire mesh. In one embodiment, one or more of the cartridges 102 can include 5-6 layers of pleated wire mesh and one or more metal fiber fleece layers. The combination of the wire mesh and metal fiber fleece can be referred to as, interchangeable, a filtration layer or mesh pack.

In FIG. 1, two different sized cartridges 102, 102′ are shown to illustrate that not all cartridges in the system 100 are required to be the same size or have the same construction. That is, a system 100 that has at least one filter cartridge that falls within this disclosure is sufficient. Preferably, more than one of the cartridges will fall within the teachings herein. It should also be understood that while shown as a system, the teachings herein can be applied to a single filter cartridge 102.

It shall be understood that each filter element/cartridge may optionally include threads or other fastener sized and configured to mate with corresponding mating elements in a receptacle plate/tube sheet 120 disposed within the housing 104. This allows for the cartridges 102 to be mated with the receptacle plate 120 such that they are held in place in the housing 104. There are many possible patterns that can be defined by the receptacle plate 120.

Any of the filter elements herein can operate such that fluid that flows into the filter housing 104 flows from an outer diameter of the filter cartridges 102 into the inner diameter thereof. The disclosure herein is especially useful when the fluid is created from a polymer (e.g., a plastic) that is being recycled. The filter cartridges 102 allow the liquid to flow inwardly from their outer diameters towards their inner diameter and removes contaminants from the liquid.

With reference to FIG. 1, the liquid can generally enter the housing 104 by inlet 111 in the inlet end 110. The flow of the liquid from the outer to inner diameter causes filter cartridges 102 to clean the liquid. Cleaned liquid exits through an exit opening of the filter cartridges 102 that is typically in the center of the filter cartridges 102. In FIG. 1, the liquid is collected at the receptacle plate 120. The cleaned liquid can pass through the receptacle plate 120 and exit the housing 104 via an outlet in the outlet end 112.

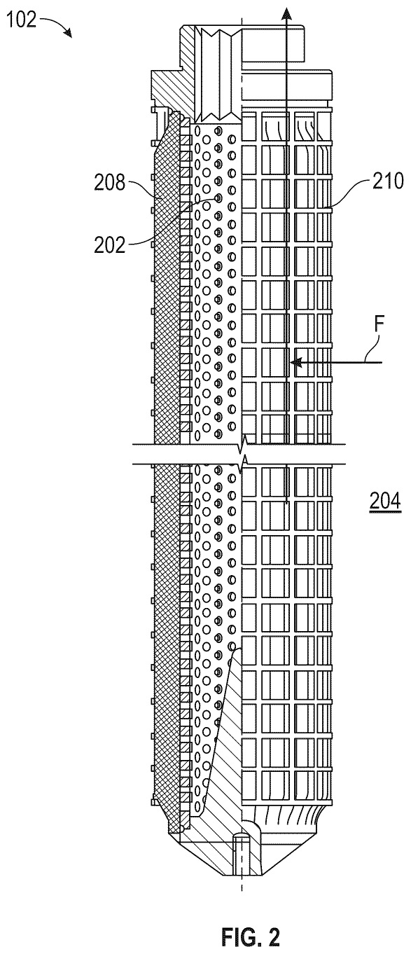

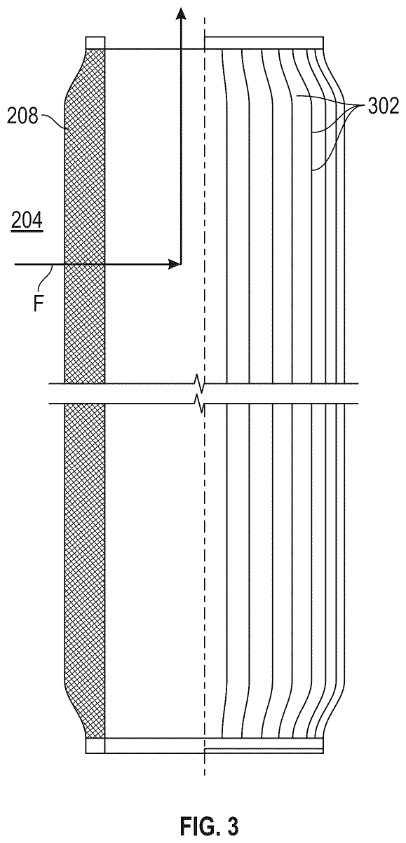

FIG. 2 is a partial cross section of an example filter cartridge 102 according to embodiment. In this example, the cartridge 102 includes a support tube 202. Flow is from a region 204 external to the cartridge 102 into the support tube 202 as shown by arrow F. This flow is also shown in more detail in FIG. 3. As is known in the art, the support tube 202 can be perforated.

The support tube 202 surrounded by a filtration layer/mesh pack 208. The filtration layer/mesh pack disclosed herein differs from prior art filtration layers at least for the reasons discussed herein. The combination of the support tube 202/mesh pack 208 can be further protected by an optional and separate outer protection layer 210. This layer can be, for example, formed of a perforated sheet.

FIG. 3 shows a partial cross section of an example mesh pack 208. The mesh pack 208 can be pleated as indicated by pleats 302. As noted above, liquid from region 204, through the mesh pack 208 and into the center of the cartridge 102 (see FIG. 1). The liquid then exits the from an upper region of the cartridge 102 as indicated generally by arrow F.

As noted above, typical mesh packs included a fleece layer with wire mesh on either side to form a three-layer mesh pack. The standard three-layer mesh pack is densely pleated to maximize the surface area. The inventors hereof have discovered, however, that such thick polymer melts have difficulty flowing between the pleats and, thereby, decreasing the effective filtration area and can limit the open space to accumulate contaminants. To address this, embodiments herein may reduce the pleats but increase the number of wire mesh layers surrounding the metal fiber fleece. Optionally, by arranging the wire mesh layers at angles to each other these layers can take on a filtration aspect to aid the fleece. This will allow for the increased flow through the fleece brought on by reducing pleats without reducing actual filtration effectiveness and provides a higher dirt holding capacity per filter surface or even per filter cartridge.

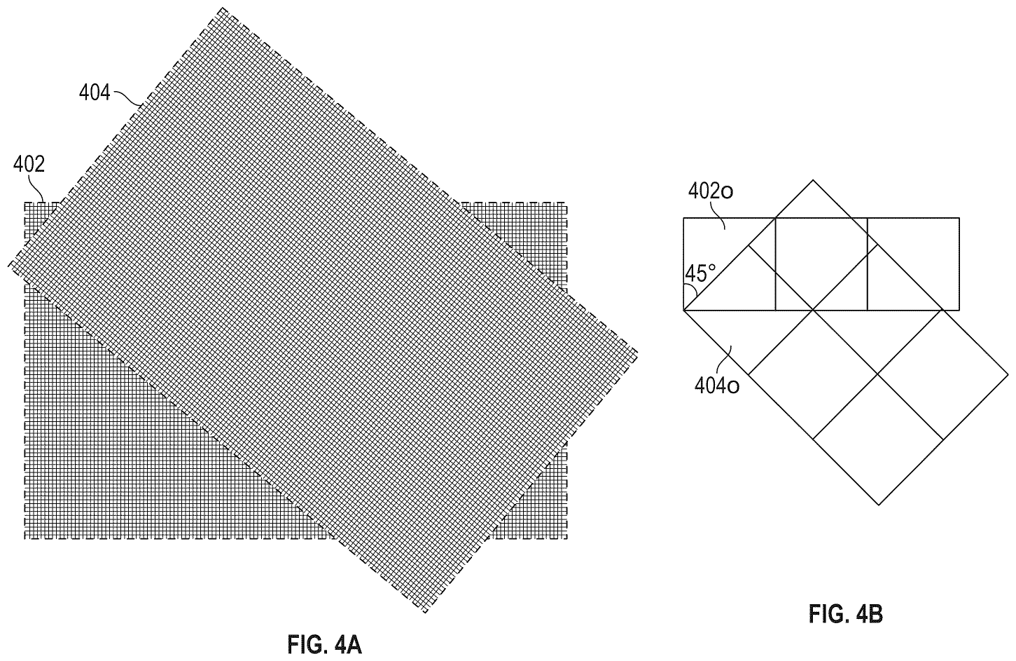

FIGS. 4A and 4B shows two example layers 402, 404 of wire mesh. FIG. 4B shows a small portion taken from any location in FIG. 4A where the layers overlap. The layers 402, 404 both define square openings 4020, 4040. Of course, the openings 402, 404 could define other shaped openings. Adjacent layers can have opening with the same or similar sizes or different sizes. Some examples are given below.

The sheets 402, 404 are shown as being rotated relative to one another. As shown, the rotation is about 45 degrees. Of course, other relative rotations could be implemented. For example, the layers could be rotated between 0 and 90 or 30 and 60 degrees relative to one another. Indeed, the layers could be rotated 30, 35, 40, 45, 50, 55, 60 or 65 degrees relative to one another. Further, rather than rotations relative to each the sizing of the mesh can be different.

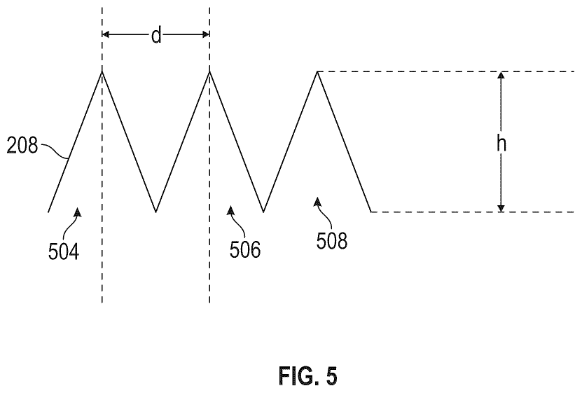

With reference now to FIG. 5, the mesh pack 208 can be formed such that it includes pleats 504, 506, 508, . . . that are spaced by distance d and have height h. The distance d will be greater than typical mesh pack due to it having more wire mesh layers. The height h of the pleats can be increased as compared to the prior art due to better stability of the thicker mesh pack/more wire mesh layers.

It shall be understood that each illustrated layer can consist of multiple layers and the FIG. 5 shows a pleated, flat mat, which is processed to the round shape, later on. Further, the tips of the pleats can have radius as opposed “sharp” tips as shown.

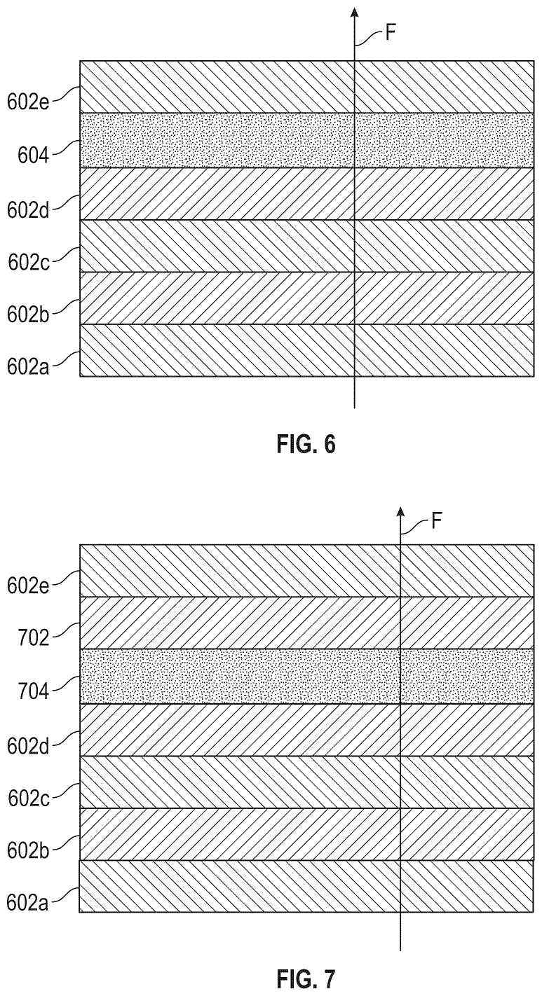

FIG. 6 shows a cross section of one embodiment of mesh pack 208. This embodiment includes 5 wire mesh layers and a sintered fleece layer. In particular, the mesh pack 208 includes four outer wire mesh layers 602a-602d and an inner wire mesh layer 602e. The sintered fleece layer 604 is shown as being disposed between layers 602d and 602e. Of course, it could be between different wire mesh layers.

One or more of the wire mesh layers 602a-602e can be rotated relative to an adjacent wire mesh layer as discussed above. Each layer wire mesh layers 602a-602e can the same or can be a combination of two or more different configurations (e.g., different mesh sizes). As shown, layers 602a, 602c and 602e are the same and 602b, 602d are the same but this is just an example. Table 1 below shows one example of wire mesh characteristics that could be utilized. Table 1 also lists a possible sintered metal fiber fleece layer 604.

For clarity, flow direction arrow F is provided in FIG. 6. As such, when formed into a cylindrical (and possibly pleated) shape, layer 602a will surround layer 602b, layer 602b will surround layer 602c, layer 602c will surround layer 602d, layer 602d will surround layer 604 and layer 604 will surround layer 602e.

Layer 602e supports and drains the metal fiber fleece layer 604 and can be referred to as an inner metal wire layer herein. While the sizing below is based on square mesh openings, other shapes (e.g., twilled mesh) could be used and can vary by layer.

TABLE 1

| Layer | Mesh Width | Wire Diameter |
|---|---|---|
| 602a | 750 μm | 260 μm |
| 602b | 400 μm | 160 μm |
| 602c | 750 μm | 260 μm |
| 602d | 400 μm | 160 μm |
| 604 | Metal fiber fleece 20 μm | Fibers of variable |
| | | diameters |
| 602e | 750 μm | 260 μm |

FIG. 7 shows a cross section of one embodiment of mesh pack 208. This embodiment includes 5 wire mesh layers and a protected metal fiber fleece layer. In particular, the mesh pack 208 includes four outer wire mesh layers 602a-602d and an inner wire mesh layer 602e. The metal fiber fleece layer 704 is laminated with a protective mesh layer 702 on its downstream side as shown. However, protective mesh layers could be provided such that they are or on either or both sides of the metal fiber fleece layer 702. It is shown as being disposed between layers 602d and 602e. Of course, it could be between different wire mesh layers.

For clarity, flow direction arrow F is provided in FIG. 7. As such, when formed into a cylindrical (and possibly pleated) shape, layer 602a will surround layer 602b, layer 602b will surround layer 602c, layer 602c will surround layer 602d, layer 602d will surround layer 704, layer 704 will surround layer 702 and layer 702 will surround layer 602e.

The one or more of the wire mesh layers 602a-602e can be rotated relative to an adjacent wire mesh layer as discussed above. Each layer wire mesh layers 602a-602e can be the same or can be a combination of two or more different configurations. As shown, layers 602a, 602c and 602e are the same and 602b, 602d are the same but this is just an example. The additional support layer 702 can be rotated relative to other layers as discussed above in one embodiment.

Table 2 below shows one example of wire mesh characteristics that could be utilized. Table 2 also lists a possible metal fiber fleece layer 704. Layer 602e supports the metal fiber fleece layer 704 and the support layer 702 and can be referred to as an inner metal wire layer herein.

TABLE 2

| Layer | Mesh Width | Wire Diameter |
|---|---|---|
| 602a | 750 μm | 260 μm |
| 602b | 400 μm | 160 μm |
| 602c | 750 μm | 260 μm |
| 602d | 400 μm | 160 μm |
| 704 | Metal fiber fleece 20 μm | Fibers of variable |
| | | diameters |
| 702 | 400 μm | 160 μm |
| 602e | 750 μm | 260 μm |

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiment disclosed as the best mode contemplated for carrying out this present disclosure, but that the present disclosure will include all embodiments falling within the scope of the claims.

What is claimed is:

1. A filter cartridge comprising:
a support tube;
a mesh pack surrounding the support tube, the mesh pack comprising:
three or more wire mesh layers, wherein at least two of the wire mesh layers are adjacent to one another and rotated relative to one another or have different sizes; and
a filtration layer arranged between the two of the three or more wire mesh layers.

2. The filter cartridge of claim 1, wherein the at least two of the wire mesh layers are rotated between 30 and 60 degrees relative to one another.

3. The filter cartridge of claim 1, wherein the at least two of the wire mesh layers are rotated 45 degrees relative to one another.

4. The filter cartridge of claim 1, wherein the filtration layer is a metal fiber fleece.

5. The filter cartridge of claim 4, wherein the metal fiber fleece layer is an un-unprotected metal fiber fleece.

6. The filter cartridge of claim 5, further comprising:
a protective layer attached to the metal fiber fleece.

7. The filter cartridge of claim 6, wherein at least three of the three or more wire mesh layers surround the metal fiber fleece and the protective layer.

8. The filter cartridge of claim 7, wherein the protective layer is formed of a wire mesh and is sintered to the metal fiber fleece layer.

9. The filter cartridge of claim 8, wherein the protective layer is formed of a wire mesh that is the same as one of the three or more wire mesh layers.

10. The filter cartridge of claim 9, wherein the three or more wire mesh layers includes four wire mesh layers that surround by the metal fiber fleece layer.

11. The filter cartridge of claim 1, wherein the three or more wire mesh layers define square or rectangular holes therein.

12. The filter cartridge of claim 1, wherein the metal fiber fleece layer includes a protective layer laminated to it.

13. The filter cartridge of claim 12, wherein the three or more wire mesh layers include an inner layer surrounded by the metal fiber fleece.

14. The filter cartridge of claim 13, wherein the three or more wire mesh layers include four wire mesh layers that surround the metal fiber fleece layer and the inner layer.

15. The filter cartridge of claim 12, wherein the three or more wire mesh layers define square or rectangular holes therein.

16. A filter system including:
one or more filter cartridges as recited in claim 1.
